(19) United States
(12) Patent Application Publication
(10) Pub. No.: US 2023/0161226 A1
(43) Pub. Date: May 25, 2023

(54) ACTUATOR ASSEMBLY

(71) Applicant: CAMBRIDGE MECHATRONICS LIMITED, Cambridge, Cambridgeshire (GB)

(72) Inventors: Stephen Bunting, Cambridge (GB); Oliver Hart, Cambridge (GB); David Ooi, Cambridge (GB); Joshua Carr, Cambridge (GB); Andrew Benjamin Simpson Brown, Cambridge (GB); James Howarth, Cambridge (GB); Robin Eddington, Cambridge (GB)

(21) Appl. No.: 17/919,069

(22) PCT Filed: Apr. 16, 2021
(86) PCT No.: PCT/GB2021/050920

§ 371 Date: Oct. 14, 2022

(30) Foreign Application Priority Data
Apr. 16, 2020 (GB) 2005573.7
Apr. 24, 2020 (GB) 2006094.3

(51) Int. Cl. G03B 5/00; G03B 3/10; H04N 23/54

(52) U.S. Cl. CPC G03B 5/00; G03B 3/10; H04N 23/54; G03B 2205/0007; G03B 2205/0076

(57) ABSTRACT

An actuator assembly (23) is described which includes first part (24), a second part (25) and a bearing arrangement (26) mechanically coupling the first part (24) to the second part (25). The bearing arrangement (26) includes a first bearing (27) mechanically coupling the first part (24) to a third part (28). The actuator assembly (23) also includes a drive arrangement (11, 20). The drive arrangement (11, 20) includes four lengths of shape memory alloy wire (14₁, 14₂, 14₃, 14₄). Each length of shape memory alloy wire (14₁, 14₂, 14₃, 14₄) is connected between the third part (28) and the second part (25). The drive arrangement (11, 20) and the bearing arrangement (26) are configured such that in response to a torque applied about a primary axis (z) by the drive arrangement (11, 20), the first bearing (27) generates movement of the first part (24) towards or away from the second part (25) and the third part (28) along the primary axis (z). The bearing arrangement (26) is configured to constrain rotation of the first part (24) relative to the second part (25) about the primary (z) axis.

### FIELD

The present application relates to an actuator assembly, particularly an actuator assembly comprising four shape-memory alloy (SMA) wires.

### BACKGROUND

Such an actuator assembly may be used, for example, in a camera to move a lens assembly in directions perpendicular to an optical axis so as to provide optical image stabilization (OIS), and to move the lens assembly along the optical axis to provide automatic focussing (AF). Where such a camera is to be incorporated into a portable electronic device such as a mobile telephone, miniaturization can be important.

WO 2013/175197 A1 describes an SMA actuation apparatus which moves a movable element relative to a support structure in two orthogonal directions using a total of four SMA actuator wires each connected at its ends between the movable element and the support structure and extending perpendicular to the primary axis. None of the SMA actuator wires are collinear, but the SMA actuator wires have an arrangement in which they are capable of being selectively driven to move the movable element relative to the support structure to any position in said range of movement without applying any net torque to the movable element in the plane of the two orthogonal directions around the primary axis.

WO 2019/243849 A1 describes a shape memory alloy actuation apparatus which comprises a support structure and a movable element. A helical bearing arrangement supported on the movable element on the support structure guides helical movement of the movable element with respect to the support structure around a helical axis. At least one shape memory alloy actuator wire is connected between the support structure and the movable element in, or at an acute angle to, a plane normal to the helical axis, so as to drive rotation of the movable element around the helical axis which the helical bearing arrangement converts into said helical movement.

WO 2019/086855 A1 describes a camera with an actuator assembly including a support platform, a moving platform that supports a lens assembly, SMA wires connected to the support platform and the moving platform, bearings to bear the moving platform on the support platform, and two arms extending between the support platform and the moving platform.

### SUMMARY

According to a first aspect of the present invention, there is provided an actuator assembly including a first part, a second part and a bearing arrangement mechanically coupling the first part to the second part. The bearing arrangement includes a first bearing mechanically coupling the first part to a third part. The actuator assembly also includes a drive arrangement. The drive arrangement includes four lengths of shape memory alloy wire. Each length of shape memory alloy wire is connected between the third part and the second part. The drive arrangement and the bearing arrangement are configured such that in response to a torque applied about a primary axis by the drive arrangement, the first bearing generates movement of the first part towards or away from the second part and the third part along the primary axis. The bearing arrangement is configured to constrain rotation of the first part relative to the second part about the primary axis.

The bearing arrangement may be configured to constrain movement of the first part relative to the second part along a first axis and/or a second axis, wherein the first and second axes are perpendicular to the primary axis and the second axis is different to the first axis. The bearing arrangement may be configured to constrain rotation of the first part relative to the second part about any of the first, second and primary axes.

The drive arrangement may include a total of four lengths of shape memory alloy wire. Neither the actuator assembly nor the drive arrangement may include any further lengths of shape memory alloy wire or other driving means. The actuator assembly may include a maximum of four lengths of shape memory alloy wire. The drive arrangement may include a maximum of four lengths of shape memory alloy wire. The first axis and/or the second axis may be perpendicular to the primary axis. The first axis may be perpendicular to the second axis.

Each of the four lengths of shape memory alloy wire corresponds to a section of shape memory alloy wire over which a drive current may be controlled independently. For example, a pair of lengths of shape memory alloy wire may be provided by a single physical wire having a first current source connected to one end, a second current source connected to the other end and a current return connection at a point between the two ends.

The first bearing may guide helical movement about and along the primary axis. The first bearing may mechanically couple a rotation about the primary axis to a translation along the primary axis.

The first bearing may include, or take the form of, a helical flexure. A helical flexure may take the form of a flat ring (or annulus) and at least three flexures extending from the flat ring. There may be four or more flexures extending from the flat ring. The flexures may be attached at equally-spaced angles around the flat ring. The flat ring and flexures may be a single-piece.

The first bearing may include, or take the form of, a helical bearing. The first bearing may include one or more helical tracks. The first bearing may include a number of ramps arranged in a loop.

The first bearing may include a number of flexible ramps arranged in a loop about the primary axis. The flexible ramps may be pre-stressed in an equilibrium or neutral configuration of the first bearing.

The bearing arrangement may also include a second bearing mechanically coupling the first part to the second part. The second bearing may be configured to guide movement of the first part towards or away from the second part along the primary axis. The second bearing may be configured to constrain movement of the first part relative to the second part along the first axis and/or the second axis. The second bearing may be configured to constrain rotation of the first part relative to second part about the primary axis. The second bearing may be configured to constrain rotation of the first part relative to second part about the first axis and/or the second axis.

The second bearing may include, or take the form of, a ball-bearing race aligned with the primary axis. The ball-bearing race aligned with the primary axis may constrain rotation of the first part relative to the second part about first, second and/or primary axes.

The second bearing may include first and second sets of flexures. Each flexure of the first and second sets of flexures may be configured to be compliant in a direction corresponding to movement of the first part relative to the third part along the primary axis. The first and second sets of flexures may be connected in parallel (between the first and second parts) and spaced apart along the primary axis.

The first and second sets of flexures may constrain rotation of the first part relative to the second part about first, second and/or primary axes. One or more, or all of the first and/or second sets of flexures may be flat (perpendicular to the primary axis). One or more, or all of the first and/or second sets of flexures may include at least one bend (or “turn” or “elbow”). One or more, or all of the first and/or second set of flexures may comprise a respective arm which may include at least one bend. One or more, or all of the arms may include a first portion extending away from the first part and a second portion running along a respective side of the first part. The first and second portions may be straight.

The bearing arrangement may also include a third bearing mechanically coupling the third part to the second part in parallel with the drive arrangement.

The third bearing may be configured to constrain movement of the third part relative to the second part along the primary axis. The third bearing may be configured to constrain rotation of the third part relative to the second part about the first and/or second axes.

The third bearing may not constrain (may permit) rotation of the third part relative to the second part about the primary axis. The third bearing may take the form of a three-point planar bearing. The third bearing may include at least three cylinders which are arranged at the points of a triangle, wherein a flat surface of each cylinder provides a sliding surface. The third bearing may include more than three cylinders. The third bearing may include at least three ball-bearings arranged at the points of a triangle. The third bearing may include more than three ball-bearings.

The four lengths of shape memory alloy wire may be substantially co-planar within a plane parallel to the first and second axes (i.e. a plane perpendicular to the primary axis).

The substantially co-planar lengths of shape memory alloy wire may be configured to apply a net force along first and/or second axes, and/or a torque about the primary axis. Within a range of motion, a net force along the first axis may be applicable substantially independently from a net force along the second axis and/or a torque about the primary axis. Within the range of motion, a net force along the second axis may be applicable substantially independently from a net force along the first axis and/or a torque about the primary axis. Within the range of motion, a torque about the primary axis may be applicable substantially independently from a net force along the first axis and/or a net force along the second axis.

Each of the four lengths of shape memory alloy wire may be not perpendicular to the primary axis. In other words, each of the four lengths of shape memory alloy wire may be inclined at an angle of more than 0 degrees and less than 90 degrees relative to the primary axis. Each of the four lengths of shape memory alloy wire may be inclined at an angle of between (and including) 10 and 25 degrees relative to a plane perpendicular to the primary axis.

First and second lengths of shape memory alloy wire may be oriented at respective angles to the primary axis and may lie substantially in planes parallel to the primary and first axes. Third and fourth lengths of shape memory alloy wire may be oriented at respective angles to the primary axis and may lie substantially in planes parallel to the primary and second axes.

The four lengths of shape memory alloy wire oriented at respective angles to the primary axis may be configured to apply a net force along the first axis in combination with a torque about the first axis. The four lengths of shape memory alloy wire oriented at respective angles to the primary axis may be configured to apply a net force along the second axis in combination with a torque about the second axis. The four lengths of shape memory alloy wire oriented at respective angles to the primary axis may be configured to apply a net force along the primary axis in combination with a torque about the primary axis.

A net force along the first axis in combination with a torque about the first axis may be applicable substantially independently of net forces and torques along and about the second axis and/or the primary axis. A net force along the second axis in combination with a torque about the second axis may be applicable substantially independently of net forces and torques along and about the first axis and/or the primary axis. A net force along the primary axis in combination with a torque about the primary axis may be applicable substantially independently of net forces and torques along and about the first axis and/or the second axis.

A camera may include the actuator assembly, an image sensor supported by one of the first part and the second part, and a lens supported by the other of the first part and the second part.

The camera may also include a controller configured to control the actuator assembly to implement an auto-focus function using the movement of the first part towards or away from the second part along the primary axis.

The camera may include one or more additional actuators configured to provide an optical image stabilisation function. The one or more additional actuators and the optical image stabilisation function may be controlled by the controller.

The controller may be a microcontroller. The controller may be an application specific integrated circuit. The controller may be one or more digital electronic processors.

According to a second aspect of the invention there is provided a method including use of the actuator assembly to implement an automatic focussing function of a camera.

According to a third aspect of the present invention, there is provided an actuator assembly including a first part, a second part and a bearing arrangement mechanically coupling the first part to the second part. The bearing arrangement includes a first bearing mechanically coupling the first part to a third part. The actuator assembly also includes a drive arrangement. The drive arrangement includes one or more lengths of shape memory alloy wire. Each length of shape memory alloy wire is connected between the third part and the second part. The drive arrangement and the bearing arrangement are configured such that in response to a torque applied about a primary axis by the drive arrangement, the first bearing generates movement of the first part towards or away from the second part and the third part along the primary axis. The bearing arrangement is configured to constrain rotation of the first part relative to the second part about the primary axis

The term ‘shape memory alloy (SMA) wire’ (or ‘length of SMA wire’) may refer to any element comprising SMA. The SMA wire may have any shape that is suitable for the purposes described herein. The SMA wire may be elongate and may have a round cross section or any other shape cross section. The cross section may vary along the length of the SMA wire. It is also possible that the length of the SMA wire (however defined) may be similar to one or more of its other dimensions. The SMA wire may be pliant or, in other words, flexible. In some examples, when connected in a straight line between two elements, the SMA wire can apply only a tensile force which urges the two elements together. In other examples, the SMA wire may be bent around an element and can apply a force to the element as the SMA wire tends to straighten under tension. The SMA wire may be beam-like or rigid and may be able to apply different (e.g. non-tensile) forces to elements. The SMA wire may or may not include material(s) and/or component(s) that are not SMA. For example, the SMA wire may comprise a core of SMA and a coating of non-SMA material. Unless the context requires otherwise, the term ‘SMA wire’ may refer to any configuration of SMA wire acting as a single actuating element which, for example, can be individually controlled to produce a force on an element. For example, the SMA wire may comprise two or more portions of SMA wire that are arranged mechanically in parallel and/or in series. In some arrangements, the SMA wire may be part of a larger piece of SMA wire. Such a larger piece of SMA wire might comprise two or more parts that are individually controllable, thereby forming two or more SMA wires.

### BRIEF DESCRIPTION OF THE DRAWINGS

Certain embodiments of the present invention will now be described, by way of example only, with reference to the accompanying drawings, in which:

FIG. 1 schematically illustrates a camera;

FIG. 2 illustrates possible translations and rotations of a lens assembly for a camera as shown in FIG. 1;

FIG. 3 schematically illustrates a first drive arrangement using four shape memory alloy (SMA) wires;

FIG. 4 is a projection view of a flat actuator assembly;

FIGS. 5A to 5C schematically illustrate a second drive arrangement using four shape memory alloy (SMA) wires;

FIG. 6 schematically illustrates a two-bar link bearing;

FIG. 7A is a plan view of a simple flexure bearing, FIG. 7B is a side view of a deformed state of the simple flexure bearing;

FIG. 8 is a plan view of a second simple flexure bearing;

FIG. 9 is an exploded projection view of a z-flexure bearing;

FIG. 10A is a side view of a first planar bearing, FIG. 10B is an exploded projection view of the first planar bearing;

FIG. 11 is a side view of a second planar bearing;

FIG. 12A is an exploded projection view of a z-translation bearing, FIG. 12B is a cross section of a portion of the z-translation bearing;

FIG. 13 is a projection view of a helical flexure bearing;

FIG. 14A is an exploded projection view of a helical bearing, FIG. 14B is a projection view of the helical bearing;

FIG. 15 is an exploded projection view of an AF actuator assembly;

FIG. 16 is a projection view of the AF actuator assembly; and

FIG. 17 schematically illustrates the AF actuator assembly.

### DETAILED DESCRIPTION

In the following, like parts are denoted by like reference numerals.

### Camera

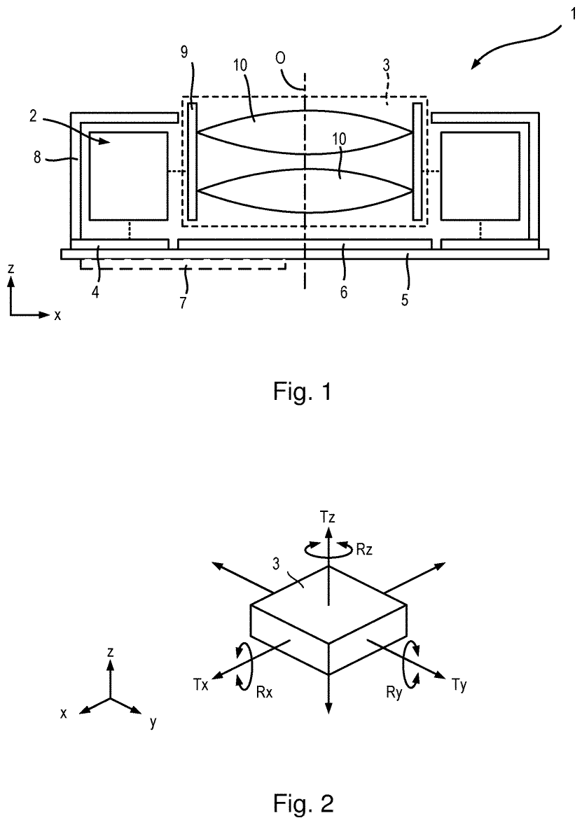

Referring to FIG. 1, a camera 1 incorporating an SMA actuator assembly 2 (herein also referred to as an “SMA actuator” or simply an “actuator”) is shown.

The camera 1 includes a first part in the form of a lens assembly 3 suspended on a second part in the form of a support structure 4 by the SMA actuator assembly 2. The SMA actuator assembly 2 supports the lens assembly 3 in a manner allowing one or more movements (or degrees-of-freedom) of the lens assembly 3 relative to the support structure 4. The lens assembly 3 has an optical axis O.

The second part in the form of the support structure 4 includes a base 5. An image sensor 6 is mounted on a front side of the base 5. On a rear side of the base 5 (i.e. the base 5 is interposed between the lens assembly 3 and the rear side), there is mounted an integrated circuit (IC) 7 in which a control circuit is implemented, and also a gyroscope sensor (not shown). Alternatively, the IC 7 may be mounted on the front side of the base 5, offset from the image sensor 6. The support structure 4 also includes a can 8 which protrudes forwardly from the base 5 to encase and protect the other components of the camera 1.

The first part in the form of the lens assembly 3 includes a lens carriage 9 in the form of a cylindrical body supporting two lenses 10 arranged along the optical axis O. In general, any number of lenses 10 may be included. Preferably, each lens 10 has a diameter of up to about 30 mm. The camera 1 can therefore be referred to as a miniature camera.

The lens assembly 3 is arranged to focus an image onto the image sensor 6. The image sensor 6 captures the image and may be of any suitable type, for example, a charge-coupled device (CCD) or a complementary metal-oxide-semiconductor (CMOS) device.

The lenses 10 are supported on the lens carriage 9 and the lens carriage 9 is supported by the SMA actuator assembly 2 such that the lens assembly 3 is movable along the optical axis O relative to the support structure 4, for example to provide focussing or zoom. Although all the lenses 10 are fixed to the lens carriage 9 in this example, in general, one or more of the lenses 10 may be mounted to a component other than the lens carriage 9, and may be fixed in place relative to the image sensor 6, leaving at least one of the lenses 10 attached to the lens carriage and movable along the optical axis O relative to the image sensor 6.

In general, the lens assembly 3 may be moved orthogonally to the optical axis O in use, relative to the image sensor 6, with the effect that the image on the image sensor 6 is moved. For example, if a set of right-handed orthogonal axes x, y, z is aligned so that a third, primary axis z is oriented substantially parallel to the optical axis O, then the lens assembly 3 may be moveable in a direction parallel to the first x axis and/or in a direction parallel to the second y axis. This is used to provide optical image stabilization (OIS), compensating for movement of the camera 1, which may be caused by hand shake etc. The movement providing OIS need not be constrained to the x-y plane. Additionally or alternatively, OIS functionality may be provided by tilting the lens assembly 3, or both the lens assembly 3 and the image sensor 6, about an axis parallel to the first axis x and/or about an axis parallel to the second y axis. Additionally or alternatively, the lens assembly 3, or at least one lens 10 thereof, may be moved parallel to the optical axis O (along/parallel to the primary axis z) to provide focussing of an image formed on the image sensor 6, for example as part of an automatic focussing (AF) function.

This specification concerns SMA actuator assemblies 2 which provide relative movements Tz of the first part relative to the second part along (or parallel to) the third (primary or optical) axis z, whilst constraining movements Tx, Ty along (or parallel to) the first and/or second axes x, y and all rotations Rx, Ry, Rz of the first part relative to the second part. This specification concerns SMA actuator assemblies 2 which may be used, for example, to provide an autofocus function for a camera 1. When an SMA actuator assembly 2 according to the present specification is used in a camera 1, one or more further or additional actuator systems (not shown) may optionally be included to provide an optical image stabilisation function.

### Shape-Memory Alloy Drive Assemblies

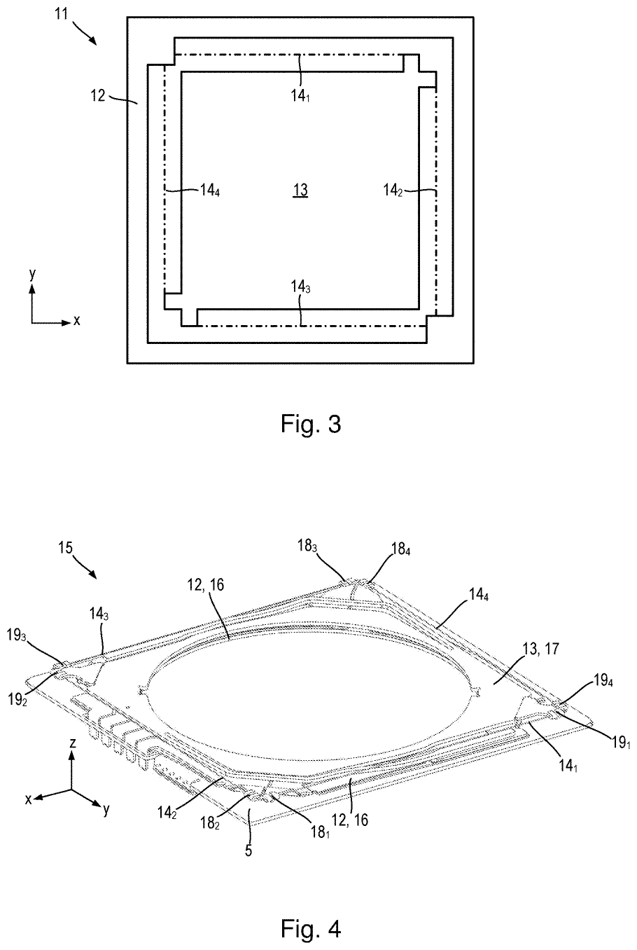

Referring also to FIG. 3, a first type of drive arrangement 11 (first drive arrangement) which may be included in SMA actuator assemblies 2 is shown schematically.

The first drive arrangement 11 includes a second structure 12 and a first structure 13. The first structure 13 is generally supported within a boundary defined by the second structure 12, for example using one or more bearings as described hereinafter. The second structure 12 generally need not provide a complete or uninterrupted boundary. The first and second structures 12, 13 may take the form of respective patterned sheets of metal, e.g., etched or machined stainless steel, and may be coated with an electrically-insulating dielectric material.

Four lengths of shape memory alloy (SMA) wire 14₁, 14₂, 14₃, 14₄ (chained lines) form a loop around the first structure 13. For brevity, lengths of SMA wire shall hereinafter be referred to primarily as “SMA wires”. First 14₁ and third 14₃ SMA wires extend substantially parallel to the first axis x and are spaced apart in a direction parallel to the second axis y. Contraction of the first SMA wire 14₁ will exert a force on the first structure 13 in the negative −x direction, whereas contraction of the third SMA wire 14₃ will exert a force on the first structure 13 in the positive +x direction. Second 14₂ and fourth 14₄ SMA wires extend substantially parallel to the second axis y and are spaced apart in a direction parallel to the first axis x. Contraction of the second SMA wire 14₂ will exert a force on the first structure 13 in the negative −y direction, whereas contraction of the fourth SMA wire 14₄ will exert a force on the first structure 13 in the positive +y direction.

Other example configurations may be used, and further details are provided in WO 2017/055788 A1 and WO 2019/086855 A1, which are both incorporated herein in their entirety by this reference.

The position of the first structure 13 relative to the second structure 12 perpendicular to the optical axis O is controlled by selectively varying the temperatures of the SMA wires 14₁, 14₂, 14₃, 14₄. This is achieved by passing selective drive signals through the SMA wires 14₁, 14₂, 14₃, 14₄ that provide resistive heating. Heating is provided directly by the drive current. Cooling is provided by reducing or ceasing the drive current to allow the SMA wires 14₁, 14₂, 14₃, 14₄ to cool by conduction, convection and radiation to its surroundings.

In operation, the SMA wires 14₁, 14₂, 14₃, 14₄ are selectively driven to move the first structure 13 relative to the second structure 12 (or vice versa) in any lateral direction (i.e., a direction within a plane parallel to first and second axes x, y and perpendicular to the optical axis O and primary axis z).

Further details are also provided in WO 2013/175197 A1, which is incorporated herein by this reference.

Taking the example of the set of four SMA wires 14₁, 14₂, 14₃, 14₄, the SMA wires 14₁, 14₂, 14₃, 14₄ have an arrangement in a loop at different angular positions around the optical axis O (corresponding here to the primary axis z) to provide two pairs of opposed SMA wires 14₁ & 14₃, 14₂ & 14₄ that are substantially perpendicular to each other. Thus, each pair of opposed SMA wires 14₁ & 14₃, 14₂ & 14₄ is capable on selective driving of moving the first structure 13 in one of two perpendicular directions orthogonal to the optical axis O. As a result, the SMA wires 14₁, 14₂, 14₃, 14₄ are capable of being selectively driven to move the first structure 13 relative to the second structure 12 to any position in a range of movement in a plane orthogonal to the optical axis O. Another way to view this movement is that contraction of any pair of adjacent SMA wires (e.g. SMA wires 14₃, 14₄) will move the first structure 13 in a direction bisecting the pair of SMA actuator wires (diagonally in FIG. 3). Another way to view this movement is that contraction of any pair of adjacent SMA wires (e.g. SMA wires 14₃, 14₄) will move the first structure 13 in a direction bisecting the pair of SMA actuator wires (diagonally in FIG. 3). Moreover, the SMA wires 14₁, 14₂, 14₃, 14₄ are capable of being actuated to generate torque about an axis parallel to the primary axis z. In particular, contraction of one pair of opposite SMA wires (e.g. SMA wires 14₁, 14₃) will produce a torque on the first structure 13 in one sense about an axis parallel to the primary axis z, and contraction of the other pair of opposite SMA wires (e.g. SMA wires 14₂, 14₄) will produce a torque in the other sense. The generation of torque and a resulting rotation may be substantially independent of the translations along directions parallel to the first and/or second axes x, y, at least over a part of the range of motion of the drive arrangement 11. The magnitude of the range of movement depends on the geometry and the range of contraction of the SMA wires 14₁, 14₂, 14₃, 14₄ within their normal operating parameters.

On heating of one of the SMA wires 14₁, 14₂, 14₃, 14₄, the stress in the SMA wire 14₁, 14₂, 14₃, 14₄ increases and it contracts, causing movement of the first structure 13 relative to the second structure 12. A range of movement occurs as the temperature of the SMA increases over a range of temperature in which there occurs the transition of the SMA material from the Martensitic phase to the Austenitic phase. Conversely, on cooling of one of the SMA wires 14₁, 14₂, 14₃, 14₄ so that the stress in the SMA wire 14₁, 14₂, 14₃, 14₄ decreases, it expands under the force from opposing ones of the SMA wires 14₁, 14₂, 14₃, 14₄ (and in some examples also biasing forces from one or more biasing means such as springs, armatures and so forth). This allows the first structure 13 to move in the opposite direction relative to the second structure 12.

The SMA wires 14₁, 14₂, 14₃, 14₄ may be made of any suitable SMA material, for example Nitinol or another titanium-alloy SMA material.

The drive signals for the SMA wires 14₁, 14₂, 14₃, 14₄ are generated and supplied by the control circuit implemented in the IC 7. For example, if the second structure 12 is fixed to (or part of) the support structure 4 (second part) and the first structure 13 is fixed to (or part or) the lens assembly 3 (first part), then the drive signals are generated by the control circuit in response to output signals of the gyroscope sensor (not shown) so as to drive movement of the lens assembly 3 to stabilise an image focused by the lens assembly 3 on the image sensor 6, thereby providing OIS. The drive signals may be generated using a resistance feedback control technique, for example as described in WO 2014/076463 A1, which is incorporated herein by this reference.

Each of the SMA wires 14₁, 14₂, 14₃, 14₄ corresponds to a length of shape memory alloy wire over which a drive current may be controlled independently.

A pair of lengths of shape memory alloy wire may be provided by a single physical wire having a first current source connected to one end, a second current source connected to the other end and a current return connection at a point between the two ends. For example, in the first drive arrangement 11, the first and second SMA wires 14₁, 14₂ may be provided by a single physical wire, with a current return provided through the first structure 13.

Referring also to FIG. 4, an example of a “flat” SMA actuator assembly 15 implementing the first drive arrangement 11 is shown.

In the flat actuator assembly 15 the second structure 12 takes the form of a flat, annular plate 16 having a rectangular outer perimeter (or “outer edge”) and a circular inner perimeter (or “inner edge”), whilst the first structure 13 takes the form of a flat, thin annular sheet 17 with a rectangular outer perimeter and a circular inner perimeter. The second structure 12 in the form of the plate 16 is supported on a base 5 in the form of a rectangular plate. The four SMA wires 14₁, 14₂, 14₃, 14₄ are each attached at one end to respective first crimps 18₁, 18₂, 18₃, 18₄ (also referred to as “static” crimps) which are fixedly attached to (or formed as part of) the second structure 12, 16. The other end of each SMA wire 14₁, 14₂, 14₃, 14₄ is attached to a respective second crimp 19₁, 19₂, 19₃, 19₄ (also referred to as a “moving” crimp) which is fixedly attached to (or formed as part of) the first structure 13, 17.

The plate 16 and the sheet 17 may each take the form of respective patterned sheets of metal, e.g., etched or machined stainless steel, and may be coated with an electrically-insulating dielectric material. The plate 16 and the sheet 17 are each provided with a respective central aperture aligned with the optical axis O allowing the passage of light from a lens assembly 3 mounted to the sheet 17 to an image sensor 6 supported on the base 5.

The four SMA wires 14₁, 14₂, 14₃, 14₄ may be perpendicular to the optical axis O or inclined at a small angle to a plane perpendicular to the optical axis O. Generally, in a set, the four SMA wires 14₁, 14₂, 14₃, 14₄are non-collinear.

The flat actuator assembly 15 includes a number of plain bearings (not shown in FIG. 4) spaced around the optical axis O to bear the first structure 13, 17 on the second structure 12, 16. Preferably, at least three bearings are used in order to assist in providing stable support, although in general, a different number of bearings may be used. Each plain bearing (not shown in FIG. 4) may take the form of a bearing member in the form of cylinder, and may be attached to, or formed as part of, the second structure 12. The plain bearings (not shown in FIG. 4) may be made from a suitable metal or alloy such as phosphor bronze or stainless steel with a diamond-like carbon coating. The plain bearings (not shown in FIG. 4) may be made from, or may include an upper layer or coating of, a polymer such as Polyoxymethylene (POM, Acetal), Polytetrafluoroethylene (PTFE), or PTFE impregnated POM. The plain bearings (not shown in FIG. 4) may be made from, or may include an upper layer or coating of Stainless steel or phosphor bronze with coatings of Titanium Carbide, Tungsten Carbon Carbide, Diamond Like Coating (DLC), Chromium Carbide DLC. These bearing materials may interface with a second bearing surface formed of one of these bearing materials, which could be polished or stamped to reduce the effects of friction generated by surface texture.

The flat actuator assembly 15 will generally also include biasing means (not shown) such as one or more springs or flexure arms arranged and configured to maintain the first and second structures 12, 13 in contact (via the plain bearings) and/or to urge the first and second structures 12, 13 towards a neutral (for example central) relative position when the SMA wires 14₁, 14₂, 14₃, 14₄ are not powered.

Details relevant to manufacturing actuator assemblies similar to the flat actuator assembly 15 can be found in WO 2016/189314 A1 which is incorporated herein in its entirety this reference.

Although not shown in FIG. 4, the flat actuator assembly 15 may be provided with end stops to provide limits on lateral movement of the first structure 13 relative to the second structure 12. In this way, the SMA wires 14₁, 14₂, 14₃, 14₄ can be protected from overextension resulting from, for example, impacts to which a device (not shown) incorporating the flat actuator assembly 15 may be subjected (for example being dropped).

As described hereinbefore, the first drive arrangement 11 can drive translations Tx, Ty along first and/or second axes x, y and rotations Rz about an axis parallel to the primary axis z (which is substantially parallel to the optical axis O). Each of these motions Tx, Ty, Rz is substantially independent of the others, at least over a part of a range of motion of the first drive arrangement. However, in order to provide translation Tz parallel to the primary axis z, the first drive arrangement 11 must be combined with at least one bearing capable of converting a torque applied about the optical axis O into a combination of rotation Rz and translation Tz (a helical movement [Tz, Rz] as described hereinafter).

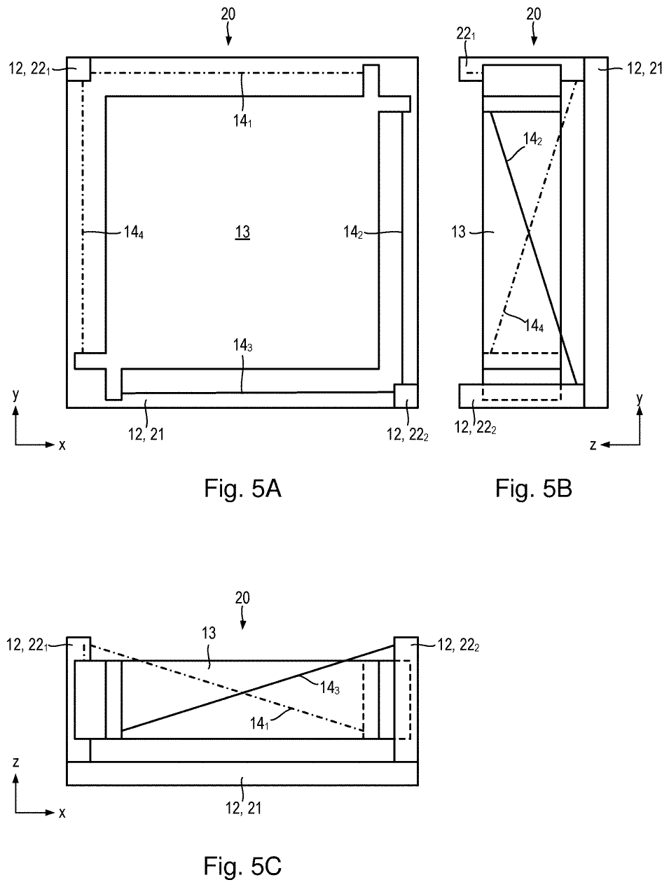

Referring also to FIGS. 5A to 5C, a second type of drive arrangement 20 (second drive arrangement) which may be included in SMA actuator assemblies 2 is shown schematically.

The second drive arrangement 20 is similar to the first drive arrangement 11 except that the second structure 12 includes a base 21 and a pair of first and second upstanding pillars 22₁, 22₂, and that the SMA wires 14₁, 14₂, 14₃, 14₄ are not substantially confined to a plane perpendicular to the primary axis z.

FIG. 5A shows the second drive arrangement 20 viewed from above, along a direction parallel to the primary axis z.

FIG. 5B shows the second drive arrangement 20 viewed from the side, along a direction parallel to the first axis x. Note that the fourth SMA wire 14₄ has been superimposed on FIG. 5B for visual purposes, even though the fourth SMA wire 14₄ would be largely obscured behind the first structure 13.

FIG. 5C shows the second drive arrangement 20 viewed from the side, along a direction parallel to the second axis y. Note that the first SMA wire 14₁ has been superimposed on FIG. 5B for visual purposes, even though the first SMA wire 14₁ would be largely obscured behind the first structure 13.

The base 21 extends beyond the edges of the first structure 13 when viewed along the primary axis (FIG. 5A), and in this example is rectangular (or square). The first pillar 22₁ is upstanding from a first corner of the base 21, and the second pillar 22₂ is upstanding from a second corner, diagonally opposite across the first structure 13.

The first SMA wire 14₁ connects from a lower portion (lower along the primary axis z) of the first structure 13 to an upper portion (higher along the primary axis z) of the first pillar 22₁. The second SMA wire 14₂ connects from an upper portion of the first structure 13 to a lower portion of the second pillar 22₂. The third SMA wire 14₃ connects from a lower portion of the first structure 13 to an upper portion of the second pillar 22₂. The fourth SMA wire 14₂connects from an upper portion of the first structure 13 to a lower portion of the first pillar 22₁.

In this way, the first SMA wire 14₁ opposes the third SMA wire 14₃ in a direction parallel to the first axis x, the second SMA wire 14₂ opposes the fourth SMA wire 14₄ in a direction parallel to the second axis y, and the first and third SMA wires 14₁, 14₃ oppose the second and fourth SMA wires 14₂, 14₄ in a direction parallel to the primary axis z.

In this way, the second drive arrangement 20, using four angled (non-coplanar) SMA wires 14₁, 14₂, 14₃, 14₄, may provide drive corresponding to Tx, Ty, Tz, Rx, Ry, Rz motions. The motions are not fully independent degrees of freedom, and in general translations will be linked to rotations, for example [Tx, Rx], [Ty, Ry] and [Tz, Rz], with the specific couplings depending on the angles of the SMA wires 14₁, 14₂, 14₃, 14₄.

The SMA wires 14₁, 14₂, 14₃, 14₄ are preferably inclined at an angle of between 10 and 25° relative to a plane perpendicular to the primary axis z.

Either or both of the second structure 12, 21 and the first structure 13 may include central apertures to permit light from a lens assembly 3 to form an image on an image sensor 6.

One of more of the motions driven by the first or second drive arrangements 11, 20 may be fully or partly constrained by mechanically coupling one or more bearings between the first and second structures 12, 13.

### Bearings

In general, a SMA actuator 2 according to this specification will include at least one of the first and second drive arrangements 11, 20 and also an arrangement of one or more mechanical bearings (also referred to as a “bearing arrangement”) serving to support, constrain and/or convert the movements generated by the first or second drive arrangement 11, 20.

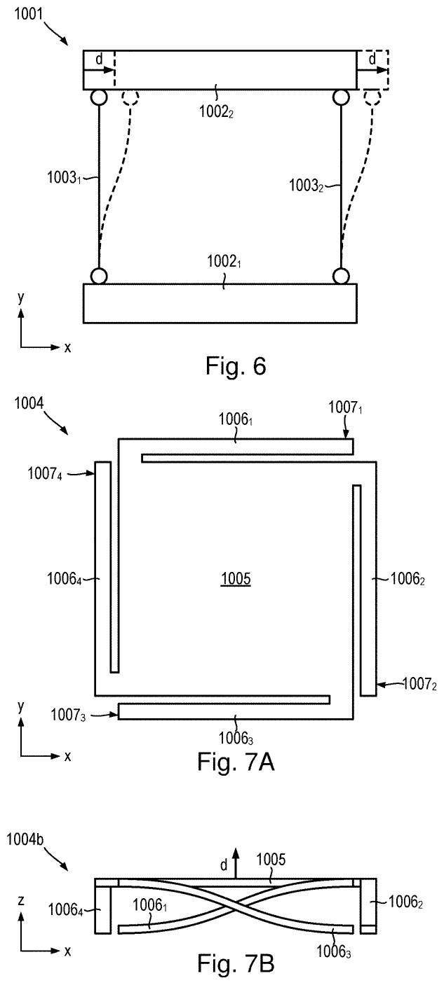

Referring also to FIG. 6, a two-bar link bearing 1001 is shown.

The two-bar link bearing 1001 includes first and second rigid portions 1002₁, 1002₂ connected by first and second beam portions 1003₁, 1003₂ (also referred to as flexures) The rigid portions 1002₁, 1002₂ are each elongated in a direction parallel to the first axis x, and are spaced apart from one another in a direction parallel to the second axis y. The beam portions 1003₁, 1003₂ are each elongated in a direction parallel to the second axis y, and are spaced apart from one another in a direction parallel to the first axis x. The beam portions 1003₁, 1003₂ are shown as being perpendicular to the rigid portions 1002₁, 1002₂, however this is not essential and any angle will work provided that the beam portions 1003₁, 1003₂ are parallel to one another. The beam portions 1003₁, 1003₂ are unable to rotate about the joints with the rigid portions 1002₁, 1002₂, for example the connections are not pin-jointed or similar.

The relative flexural rigidities of the beam portions 1003₁, 1003₂ and the rigid portions 1002₁, 1002₂ are selected (primarily using the dimensions and shapes of cross-sections) so that if the first rigid portion 1002₁ is clamped, the second rigid portion 1002₂ may move relative to the first rigid portion 1002₁ via bending of the beam portions 1003₁, 1003₂ in the x-y and/or x-z planes. In this way, the two-bar link 1001 is able to provide for relative movements Tx, Tz, Rx and Ry between the first and second rigid portions 1002₁, 1002₂. A deformed state in which the second rigid portion 1002₂ is displaced by a distance d parallel to the first axis is also shown in FIG. 6 using dashed lines. The two-bar link bearing 1001 may be rotated 90 degrees to provide movement Ty parallel to the second axis y instead of Tx.

The relative resistance to bending in x-y versus y-z planes may be controlled by using the cross-sectional shape of the beam portions 1003₁, 1003₂ to select relative flexural rigidities.

Referring also to FIG. 7A, a tiltable z-flexure in the form of a two-by-two parallel bar link bearing 1004 (also referred to as a simple flexure) is shown.

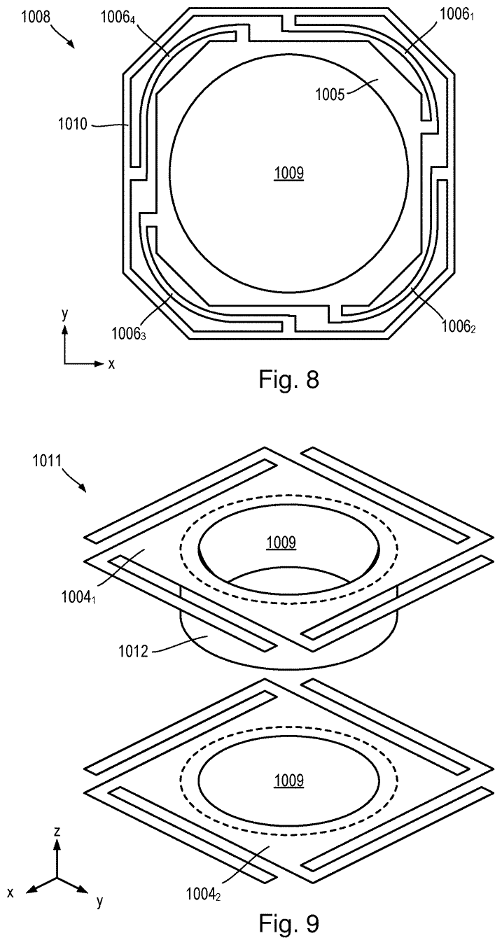

The simple flexure 1004 includes a central portion 1005 and two pairs of beam portions (or flexures) 1006₁, 1006₂, 1006₃, 1006₄. Each beam portion (or flexure) 1006₁, 1006₂, 1006₃, 1006₄ is rigidly connected to the central portion 1005 at one end, and has a second, free end 1007₁, 1007₂, 1007₃, 1007₄. In some examples the central portion 1005 may also have a central aperture 1009 (FIG. 8). The first and third beam portions (flexures) 1006₁, 1006₃ are elongated in a direction parallel to the first axis x, and are able to deform by beam bending in the x-z plane. Similarly, the second and fourth beam portions (flexures) 1006₂, 1006₄ are elongated in a direction parallel to the second axis y, and are able to deform e.g. by beam bending in the y-z plane. Deflection of beam portions (or flexures) 1006₁, 1006₂, 1006₃, 1006₄ laterally (perpendicular to the primary axis z) is constrained by the connection of all the beam portions (or flexures) 1006₁, 1006₂, 1006₃, 1006₄ to the central portion 1005 and/or by the cross-sectional shapes of the beam portions 1006₁, 1006₂, 1006₃, 1006₄.

In this way, if the free ends 1007 are clamped, the simple flexure 1004 is able to provide for relative movements Tz, Rx and/or Ry between the central portion 1005 and the clamped free ends 1007.

Referring also to FIG. 7B, a deformed state 1004b of the simple flexure of FIG. 7A is shown in which the central portion 1005 is displaced by a distance d parallel to the primary axis z.

Referring also to FIG. 8, a second simple flexure (tiltable z-flexure) 1008 is shown.

The second simple flexure 1008 is the same as the simple flexure 1004, except that the central portion 1005 includes a central aperture 1009, that the ends of the beam portions 1006₁, 1006₂, 1006₃, 1006₄ not connected to the central portion 1005 are connected to an outer annulus 1010, and that the beam portions 1006₁, 1006₂, 1006₃, 1006₄ are curved instead of straight. The second simple flexure 1008 functions in substantially the same way as the simple flexure 1004. In particular, if the outer annulus is clamped, then the central portion 1005 may move in Tz, Rx and/or Ry.

The presence or absence of a central aperture 1009 in the second simple flexure 1008 or the simple flexure 1004 may depend on the position within a device, for example the camera 1. A simple flexure 1004, 1008 located below the image sensor 6 will not generally require a central aperture 1009, whereas a simple flexure 1004, 1008 located above the image sensor 6 will generally require a central aperture 1009.

Referring also to FIG. 9, a z-flexure 1011 is shown.

The z-flexure includes a pair of simple flexures 1004₁, 1004₂ disposed perpendicular to the primary axis z (when not deformed), and spaced apart in a direction parallel to the primary axis z by a rigid structure 1012 sandwiched between the pair of simple flexures 1004₁, 1004₂. The simple flexures 1004₁, 1004₂ are fixed to opposed faces of the rigid structure 1012. The simple flexures 1004₁, 1004₂ each include a central aperture 1009. The illustration in FIG. 9 shows the rigid structure 1012 fixed to one of the simple flexures 1004₁ and detached from the other simple flexure 1004₂ for visual purposes, though in use both simple flexures 1004₁, 1004₂ are fixed to the rigid structure 1012. Dashed lines in FIG. 9 illustrate the projected outline of the rigid structure 1012.

In this way, each individual beam portion 1006 of each simple flexure 1004₁, 1004₂ may deflect. However, the separation of the simple flexures 1004₁, 1004₂ in a direction parallel to the primary axis z and the fixed connection via the rigid structure 1012 constrains movements Tx, Ty, Rx, Ry, Rz whilst guiding movement Tz in a direction parallel to the primary axis z.

In this example the rigid structure 1012 is a hollow cylinder having an inner diameter equal to the diameter of the central apertures 1009. However, the rigid structure 1012 may have any shape suitable for spacing the simple flexures apart parallel to the primary axis z and compatible with an intended application of an actuator.

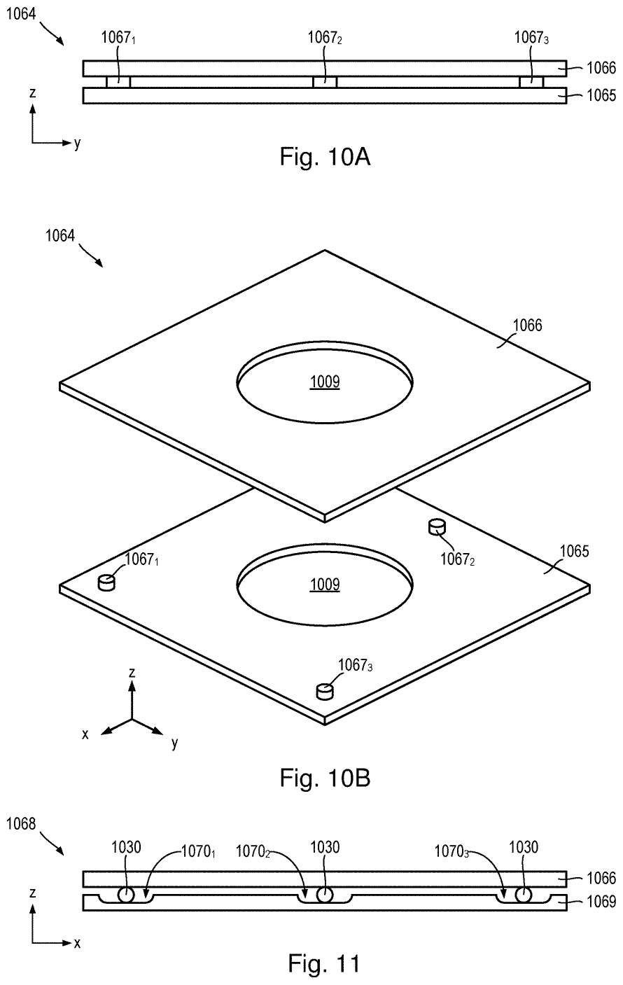

Referring also to FIGS. 10A and 10B, a first planar bearing 1064 (also referred to as a three-point bearing herein) is shown.

FIG. 10A is a side view and FIG. 10B is an exploded projection view.

The first planar bearing 1064 includes a first plate 1065 which slides in contact with a second plate 1066. The first plate 1065 supports at least three cylindrical protrusions 1067 including at least first 1067₁, second 1067₂ and third 1067₃ cylindrical protrusions which are not co-linear, for example arranged at the points of a triangle. The second plate 1066 is urged into contact with the flat surfaces of the cylindrical protrusions 1067 by biasing means (not shown in FIGS. 10A and 10B), and is free to slide in a plane parallel to the first and second axes x, y, and to rotate about an axis parallel to the primary axis z. In this way, the relative motions between the first plate 1065 and the second plate 1066 correspond to Tx, Ty and/or Rz. Unless a biasing force urging the plates 1065, 1066 together is overcome, the movements Tz, Rx and Ry are constrained.

In the example shown in FIGS. 10A and 10B, both plates 1065, 1066 take the form of an annulus having a rectangular outer perimeter and a circular inner perimeter defining a central aperture 1009. However, the shape of the plates 1065, 1066 is not relevant to the function of the first planar bearing 1064, and any shapes of plate may be used instead. Although three cylindrical protrusions 1067₁, 1067₂, 1067₃ are shown in FIGS. 10A and 10B, in general any number of cylindrical protrusions greater than or equal to three may be used. The flat actuator assembly 15 (FIG. 4) includes an implementation of a first planar bearing 1064.

Referring also to FIG. 11, a second planar bearing 1068 is shown.

The second planar bearing 1068 is the same as the first planar bearing 1064, except that the cylindrical protrusions 67 are replaced by ball bearings 1030₁, 1030₂, 1030₃. The first plate 1065 may also be replaced with a third plate 1069 including recesses 1070₁, 1070₂, 1070₃, for example circular indents, for receiving corresponding ball bearings 1030₁, 1030₂, 1030₃. The second planar bearing 1068 functions in the same way as the first planar bearing 1064, except that the second planar bearing 1068 is a rolling bearing instead of a plain bearing.

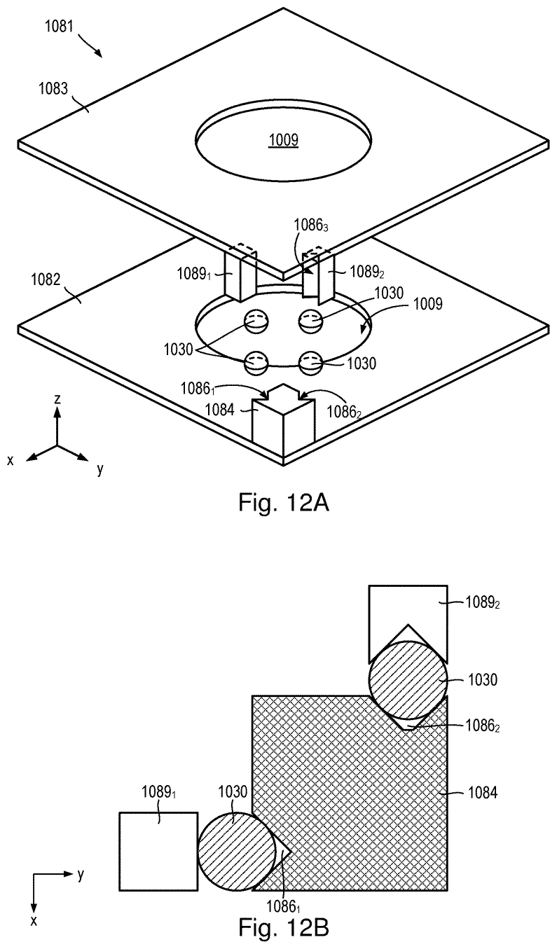

Referring also to FIGS. 12A and 12B, a z-translation bearing 1081 is shown.

FIG. 12A shows an exploded projection view and FIG. 12B shows a section through a block 1084 of the assembled z-translation bearing 1081.

The z-translation bearing 1081 includes a first plate 1082 and a second plate 1083. Both plates 1082, 1083 take the form of an annulus having a rectangular outer perimeter and a circular inner perimeter defining a central aperture 1009. A block 1084 extends perpendicular to a surface of the first plate 1082. As drawn in FIG. 12A, the first and second plates 1082, 1083 are parallel to the first and second axes x, y and the block 1084 extends in a direction parallel to the primary axis z. The block 1084 is generally cuboidal, with the exceptions of first and second faces of the block 1084 including V-shaped channels 1086₁, 1086₂ oriented substantially parallel with the primary axis z.

A pair of ball bearings 1030 is received into each V-shaped channel 1086₁, 1086₂, and the ball bearings 1030 are retained in the V-shaped channels 1086₁, 1086₂ by respective cuboidal protrusions 1089₁, 1089₂ which extend from the second plate 1083 which. At least one (in other examples both) of the cuboidal protrusions 1089₁, 1089₂ includes a V-shaped channel 1086₃ configured to oppose one of the V-shaped channels 1086₁, 1086₂ of the block 1084. Biasing means (not shown) for loading the bearings and ball-retaining means (not shown) are also generally included.

In this way, permitted relative motions between the first plate 1082 and the second plate 1083 correspond to Tz, whilst all other movements Tx, Ty, Rx, Ry, Rz are constrained.

Although a single block 1084 and corresponding protrusions 1089₁, 1089₂ are shown in FIGS. 12A and 12B, in some example two or more blocks 1084 may be used in conjunction with corresponding sets of corresponding protrusions 1089₁, 1089₂.

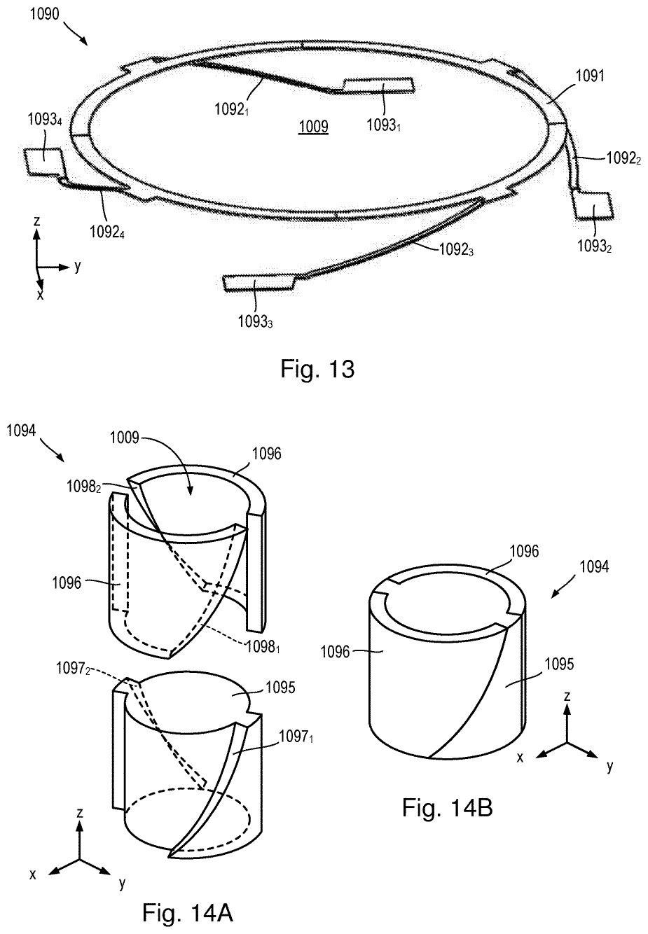

Referring also to FIG. 13, an example of a helical flexure bearing 1090 is shown.

The helical flexure bearing 1090 includes a circular annulus 1091 having a central aperture 1009 and connected to three or more (preferably four or five) helical beam portions 1092. In the example shown in FIG. 13, there are four helical beam portions 1092₁, 1092₂, 1092₃, 1092₄. At the end not connected to the circular annulus, each helical beam portion 1092₁, 1092₂, 1092₃, 1092₄ is connected to a pad 1093₁, 1093₂, 1093₃, 1093₄, for example for connection to a layer or structure below (in relation to the primary axis z as drawn) the circular annulus 1091.

Each helical beam portion 1092₁, 1092₂, 1092₃, 1092₄ is approximately tangential to the circular annulus 1091 (in the same sense) and its span includes both a first component parallel to the plane containing the first and second axes x, y and a second component parallel to the primary axis z. If the pads 1093₁, 1093₂, 1093₃, 1093₄ are clamped and a force is exerted upwards (positive z direction) on the circular annulus 1091, then in response the helical beam portions 1092₁, 1092₂, 1092₃, 1092₄ will deflect in the direction of that force. However, in doing so, the ends connected to the circular annulus 1091 are also deflected closer the respective pad 1093₁, 1093₂, 1093₃, 1093₄, causing the circular annulus 1091 to rotate clockwise about an axis parallel to the primary axis z. Conversely, a force exerted downwards (negative z direction) on the circular annulus 1091 will result in both a downwards movement of the circular annulus 1091 and also an anti-clockwise (counter-clockwise) rotation of the circular annulus 1091.

In this way, the helical flexure bearing 1090 acts to convert a relative displacement parallel to the primary axis z into a rotation about the primary axis z and to convert a rotation about the primary axis z into a relative displacement parallel to the primary axis z. However, the movements are not independent of one another, and relative to clamped pads 1093₁, 1093₂, 1093₃, 1093₄ the circular annulus 1091 is constrained to move along an approximately helical path. Since this does not reflect independent degrees-of-freedom, the motion will be denoted as [Tz, Rz] to highlight the relationship between translation Tz parallel to the primary axis z and rotation Rz about the primary axis z for this bearing type.

Although the helical beam portions 1092₁, 1092₂, 1092₃, 1092₄ shown in FIG. 13 are curving, in other examples of helical flexure bearings 1090 the helical beam portions 1091 may be straight. Further examples of helical flexure bearings 1090 are described in WO 2019/243849 A1, the contents of which are incorporated herein by reference in their entirety. FIGS. 19 to 22 of WO 2019/243849 A1 and the accompanying description on page 22, line 23 to page 23, line 24 are particularly relevant to helical flexure bearings 1090. Additional examples of implementing helical flexure bearings 1090 are also shown and described hereinafter.

Referring also to FIGS. 14A and 14B, an example of a helical bearing 1094 is shown.

FIG. 14A is an exploded projection view and FIG. 14B is a projection of the assembled helical bearing 1094. Occluded features are shown using dashed lines in FIG. 14A.

The helical bearing 1094 includes a first structure 1095 and a second structure 1096 configured to fit together for sliding motion between helical surfaces 1097₁, 1097₂ of the first structure 1095 and helical surfaces 1098₁, 1098₂ of the second structure 1096. Biasing means (not shown) urge the first and second structures 1095, 1096 together to maintain the pairs of helical surfaces 1097₁ and 1098₁, 1097₂, 1098₂ in contact. In this way, the relative motions between the first and second structures 1095, 1096 are constrained to a helical path [Tz, Rz].

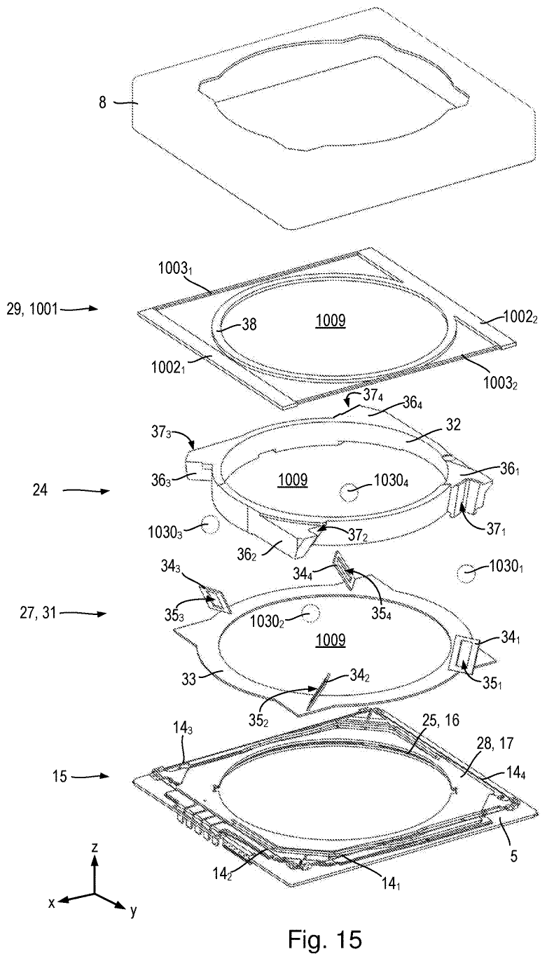

The example shown in FIGS. 14A and 14B prioritises visual clarity of the functioning of a helical bearing over practicality of implementation, and specific embodiments described hereinafter include additional examples more suited to incorporation into a device such as a camera 1. In particular, although the helical surfaces 1097, 1098 may be curved to follow a helical path as shown in FIGS. 14A and 14B, in other examples the helical surfaces 1097, 1098 may be substantially planar, for example ramps 34 (FIG. 15). Although the helical bearing 1094 shown in FIGS. 14A and 14B is a plain bearing, other helical bearings in the form of rolling bearings 31 (FIG. 15) are also possible. Further examples of helical bearings 1094 may be found in WO 2019/243849 A1 (already incorporated by reference). In particular, see FIGS. 1 to 18 of WO 2019/243849 A1 and the corresponding description on page 7, line 10 to page 22, line 21.

Although illustrated and described in particular orientations with respect to a set of right-handed Cartesian axes x, y, z for reference, any of the bearings described hereinbefore may be oriented at an arbitrary angle.

The bearings described hereinbefore may be formed of any suitable materials and using any suitable fabrication methods. For example, plate- or sheet-like components may be fabricated from metal sheets, for example stainless steel, with patterning provided by chemical or laser etching. Milling or stamping could be used provided that this does not unacceptably introduce residual strains causing distortion of parts. After patterning, such parts may be bent or pre-deformed as needed. Complex three-dimensional parts may be built up by attaching parts to plates, sheets or other parts, for example using adhesives, welding, brazing, soldering and so forth. Alternatively, complex three-dimensional parts may be formed by, for example, sintering or die-casting of metals, or by injection moulding of polymers. Any bearing surfaces may be made from, or may include an upper layer or coating of, a polymer such as Polyoxymethylene (POM, Acetal), Polytetrafluoroethylene (PTFE), or PTFE impregnated POM. Any bearing surfaces may be made from, or may include an upper layer or coating of Stainless steel or phosphor bronze with coatings of Titanium Carbide, Tungsten Carbon Carbide, Diamond Like Coating (DLC), Chromium Carbide DLC. These bearing materials may interface with a second bearing surface formed of one of these bearing materials, which could be polished or stamped to reduce the effects of friction generated by surface texture.

### AF Actuator Assembly

Referring also to FIGS. 15 to 17, an AF actuator assembly 23 (hereinafter actuator assembly) is shown.

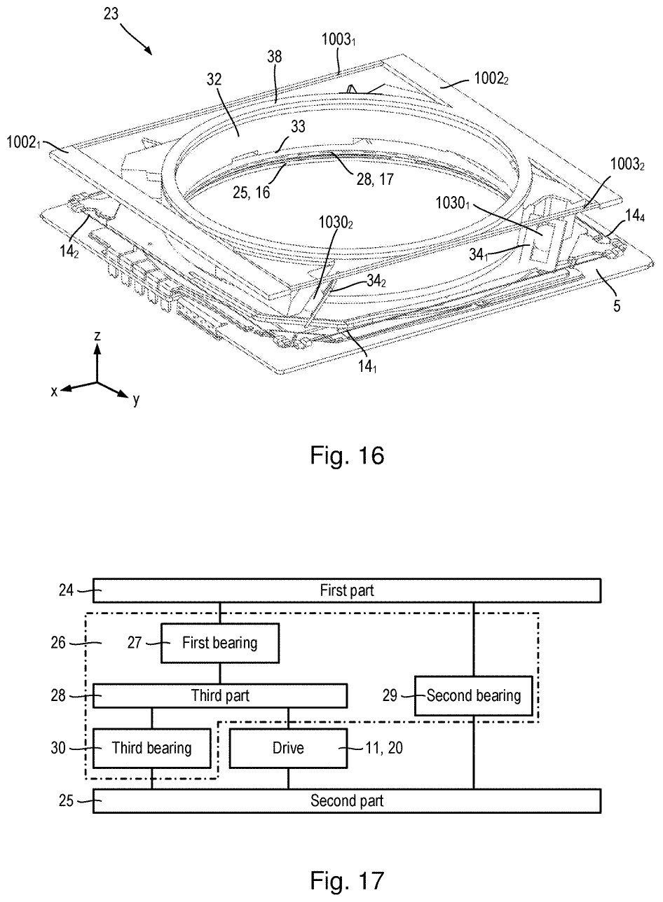

FIG. 15 shows an exploded perspective view of the actuator assembly 23, FIG. 16 shows a perspective view and FIG. 17 is a schematic.

Referring in particular to FIG. 17, the actuator assembly 23 includes a first part 24, a second part 25, a bearing arrangement 26 mechanically coupling the first part 24 to the second part 25, and a drive arrangement 11, 20.

The functions of the first actuator assembly 23 shall be described with reference to a set of axes fixed to the second part 25. A primary axis z corresponds to a direction which, when used in a camera 1, would coincide with or be parallel to the optical axis O. First x and second axes y are perpendicular to the primary axis z, and to one another.

The drive arrangement 11, 20 and the bearing arrangement 26 are configured such that the first part 24 is movable towards or away from the second part 25 along the primary axis z. The bearing arrangement 26 is also configured to constrain movement Tx, Ty of the first part 24 relative to the second part 25 along the first axis x and/or the second axis y, and to constrain rotation Rx, Ry, Rz of the first part 24 relative to the second part 25 about any of the first, second and primary axes x, y, z.

The bearing arrangement 26 includes a first bearing 27 mechanically coupling the first part 24 to a third part 28. Each shape memory alloy wire 14₁, 14₂, 14₃, 14₄ of the drive arrangement 11, is connected between the second part 25 and the third part 28. The first bearing 27 is configured to generate, in response to a torque applied about the primary axis z by the drive arrangement 11, 20, movement of the first part 24 towards or away from the third part 28 (and second part 25) along the primary axis z. The first bearing 27 provides this function by guiding helical movement [Tz, Rz] about and along the primary axis z, by coupling a rotation Rz about the primary axis z to a translation Tz along the primary axis z.

A rotation of the first bearing 27 about the primary axis z will correspond to a rotation of the third part 28 relative to the first part 24 (and second part 25) about the primary axis z. The first part 24 does not rotate about the primary axis z relative to the second part 25.

The bearing arrangement 26 also includes a second bearing 29 mechanically coupling the first part 24 to the second part 25 and configured to guide movement of the first part 24 towards or away from the second part 25 along the primary axis z whilst constraining movement of the first part 24 relative to the second part 25 along the first axis x and/or the second axis y, and also constraining rotation Rz of the first part 24 relative to second part 25 about the primary axis z.

The bearing arrangement 26 also includes a third bearing 30 mechanically coupling the third part 28 to the second part 25 in parallel with the drive arrangement 11, 20. The third bearing 30 may be configured to constrain movement Tz of the third part 28 relative to the second part 25 along the primary axis z, and to constrain rotation Rx, Ry of the third part 28 relative to the second part 25 about the first and/or second axes x, y. The third bearing 30 should not constrain (i.e. permit) rotation Rz of the third part 28 relative to the second part 25 about the primary axis z.

Referring in particular to FIGS. 15 and 16, one example implementation of the actuator assembly 23 shall be described in greater detail. The can 8 is omitted from FIG. 16 for visual purposes.

The actuator assembly 23 includes the flat actuator assembly 15 (see FIG. 4 in particular), of which the annular plate 16 provides the second part 25 and the annular sheet 17 provides the third part 28. As described hereinbefore (in relation to FIG. 4), the annular sheet 17 is coupled to the annular plate 16 using the four SMA wires 14₁, 14₂, 14₃, 14₄ and slides over a third bearing 30 in the form of a planar bearing provided by three or more cylindrical protrusions (not shown in FIG. 15—see e.g. 1067₁, 1067₂ and 1067₃ in FIG. 10B).

A first bearing 27 in the form of a helical roller bearing 31 mechanically couples the third part 28 in the form of the annular sheet 17 to a first part 24 in the form of a lens carriage 32 which performs the function of supporting a lens or lenses 10 of a lens assembly 3 in the same way as lens carriage 9. The helical roller bearing 31 includes an annulus 33 having a circular inner perimeter defining a central aperture 1009, and an outer perimeter which alternates between rectangular and circular outlines. The annulus 33 supports four ramps 34₁, 34₂, 34₃, 34₄ equi-spaced in a loop about the central aperture 1009. Each ramp 34₁, 34₂, 34₃, 34₄ takes the form of a rectangular frame having an elongated aperture 35₁, 35₂, 35₃, 35₄ extending along a length of the ramp 34₁, 34₂, 34₃, 34₄. The ramps 34₁, 34₂, 34₃, 34₄ all make substantially equal angles to the annulus 33 (which lies in a plane parallel to first and second axes x, y). When assembled, each elongated aperture 35₁, 35₂, 35₃, 35₄ receives a corresponding ball bearing 1030₁, 1030₂, 1030₃, 1030₄.

The lens carriage 32 is generally cylindrical about a central aperture 1009 for mounting of one or more lenses 10. The lens carriage 32 also includes four protrusions 36₁, 36₂, 36₃, 36₄ extending radially outwards from the generally cylindrical lens carriage 32. The first protrusion 36₁ defines a first bearing surface 37₁ in the form of a V-shaped channel. The first bearing surface 37₁ is oriented generally upwards (normals to the first bearing surface 37₁ have components generally in the positive +z direction along the primary axis z). The second protrusion 36₂ defines a second bearing surface 37₂ in the form of a V-shaped channel oriented generally downwards (normals to the second bearing surface 37₂ have components generally in the negative −z direction along the primary axis z). The third protrusion 36₃ defines a third bearing surface 37₃ in the form of an angled planar surface oriented generally upwards (normals to the third bearing surface 37₃ have components generally in the positive +z direction along the primary axis z). The fourth protrusion 36₄ defines a fourth bearing surface 37₄ in the form of an angled planar surface oriented generally downwards (normals to the fourth bearing surface 37₄ have components generally in the negative −z direction along the primary axis z).

When assembled, each bearing surface 37₁, 37₂, 37₃, 37₄ is in rolling contact with the corresponding ramp 34₁, 34₂, 34₃, 34₄ via the respective ball bearing 1030₁, 1030₂, 1030₃, 1030₄. However, the first and third bearing surfaces 37₁, 37₃ will lie below (relative to the primary axis z) the corresponding ramps 34₁, 34₃, whereas the second and fourth bearing surfaces 37₂, 37₄ will lie above the corresponding ramps 34₂, 34₄. This arrangement may be observed in FIG. 16.

The annulus 33 is fixed to the annular sheet 17 (third part 28), for example by welding, adhesive or another suitable attachment method. An upper surface (relative to the primary axis z) of the lens carriage 32 (first part 24) is fixed to a central annular portion 38 of the second bearing 29. The second bearing 29 takes the form of two-bar link 1001, additionally including a central annular portion 38 rigidly attached to (or integrated with) the second rigid portion 1002₂. The central annular portion 38 takes the form of a circular annulus.

The first rigid portion 1002₁ is then rigidly connected to the annular plate 16 (second part 25) via the can 8 and base 5, to complete the coupling between the second part 25 in the form of the annular plate 16 and the first part 24 in the form of the lens carriage 32. For example, the first rigid portion 1002₁ is attached to the can 8, and the interior boundaries of the can 8 are dimensioned to abut (or nearly abut) the edges of the first and second beam portions 1003₁, 1003₂ in order to prevent movement Ty of the second rigid portion 1002₂ relative to the first rigid portion 1002₁ along the second axis y (as oriented in FIGS. 15 and 16). This configuration leaves the first and second beam portions 1003₁, 1003₂ to deflect along the primary axis z along with the lens carriage 32 (first part 24).

The combination of the first and second bearings 27, 29 constrains any response to a lateral force (substantially perpendicular to the primary axis z) applied by the first drive arrangement 11. In use, the first drive arrangement 11 will not be caused to apply a lateral force (since this would have no useful effect given the bearing arrangement 26).

However, when the first drive arrangement 11 is caused to apply a torque about the primary axis z, the third part 28 in the form of the annular sheet 17, and the attached annulus 33 and ramps 34₁, 34₂, 34₃, 34₄ will rotate Rz about the primary axis z in response. This rotation will cause the ball bearings 1030₁, 1030₂, 1030₃, 1030₄ to roll between the ramps 34₁, 34₂, 34₃, 34₄ and bearing surfaces 37₁, 37₂, 37₃, 37₄, displacing the lens carriage 32 (first part 24) up or down (relative to the primary axis z) depending on the direction of the torque and corresponding rotation Rz. However, the lens carriage 32 (first part 24) does not rotate Rz about the primary axis z because of the constraint provided by the second bearing. Besides facilitating up or down movement of the lens carriage 57 (first part 24), the under-over-under-over configuration of the ramps 34₁, 34₂, 34₃, 34₄ and bearing surfaces 37₁, 37₂, 37₃, 37₄ means that, when the actuator assembly 23 is assembled the ramps 34₁, 34₂, 34₃, 34₄ are flexed, providing a loading force for the first bearing 27.

Although shown in FIGS. 15 and 16 using the first (flat) drive arrangement 11, the second (angled) drive arrangement 20 may be used instead. The angled drive arrangement 20 may apply a force along the primary axis z in combination with a torque about the primary axis z, which may help with smoother helical movement [Tz, Rz] of the first bearing 27.

In this way, an AF function may be provided using a single drive arrangement 11, 20 including a total of four SMA wires 14₁, 14₂, 14₃, 14₄, whilst also avoiding rotation Rz of lenses 10 about the primary axis z. Compared to a simple helical flexure or bearing which would also rotate Rz a lens 10 about the primary axis z, this may improve the quality of images by reducing the possibility of aberrations resulting from imperfect circular symmetry of one or more lenses 10. Using the first bearing 27 to convert torque into translation Tz along the primary axis z may enable increased stroke length from using longer SMA wires 14₁, 14₂, 14₃, 14₄ (longer compared to SMA wires oriented along the primary axis), whilst maintaining a low profile of a camera 1 along the primary axis z.

When the actuator assembly 23 is used in a camera 1 to provide an autofocus function, one or more further or additional actuator systems (not shown) may optionally be included to provide a separate optical image stabilisation function.

Each of the four shape memory alloy wires 14₁, 14₂, 14₃, 14₄, corresponds to a section of shape memory alloy wire over which a drive current may be controlled independently. For example, a pair of shape memory alloy wires 14₁, 14₂, 14₃, 14₄ may be provided by a single physical wire having a first current source (not shown) connected to one end, a second current source (not shown) connected to the other end and a current return connection (not shown) at a point between the two ends.

Although the actuator assembly 23 has been explained with the second part 25 corresponding to a support structure 4 of a camera 1 and the first part 24 corresponding to a lens carriage 9, 32 of a lens assembly 3, the roles may be reversed so that the second part 25 corresponds to a lens carriage 9, 32 and the first part 24 provides a support structure 4. Equally, the actuator assembly 23 need not be restricted to use in a camera 1, and the first and second parts 24, 25 may be any parts requiring the relative motion Tz.

Although shown in FIGS. 15 and 16 using a particular type of helical roller bearing 31, the first bearing 27 may be any type of bearing or flexure which responds to an applied torque with helical motion [Tz, Rz]. For example, the helical flexure bearing 1090, the helical bearing 1094, or any of the alternatives described in WO 2019/243849 A1 and referenced hereinbefore. In general, a helical flexure may take the form of a flat ring (or annulus) and at least three flexures extending from the flat ring. The flat ring and flexures may be a single-piece.

Although shown in FIGS. 15 and 16 using a two-bar link 1001 additionally constrained against lateral motion Ty by abutment of the can, the second bearing 29 may be implemented using any bearing which guides motion Tz along the primary axis z whilst constraining rotation Rz about the primary axis z. For example, the second bearing 29 may take the form of a z-flexure 1011, a z-translation bearing 1081, or any other type of bearing having the motions and constraints described hereinbefore.

Although shown in FIGS. 15 and 16 as an annular sheet 17, the third part 28 may in general be any structure suitable for mechanically coupling the first and second bearings 27, 29.

The third bearing 30 may be provided by any bearing suitable for guiding rotation Rz of the third part 28 relative to the second part 25, for example the first planar bearing 1064 or the second planar bearing 1068.

As explained hereinbefore, the actuator assembly 23 may help to avoid any lens quality concerns associated with rotation of the lens 10 when motion Tz along the primary axis z is generated using the helical bearing/flexure. Additionally, parts such as the second bearing 29 and/or the annulus 33 and ramps 34 of the first bearing 27 may be formed from chemical or laser etching of sheets of metal, for example stainless steel. The etchings may be bent following etching to angle the ramps 34. Alternatively, such parts may be formed by stamping of a metal sheet, combining removal of unwanted material with bending of parts into shape, although this approach is only possible when residual stresses in the formed parts will not result in undue distortion. Stamping combined with in-situ heating to permit creep relaxation could be considered. This may reduce manufacturing complexity.

The configuration of the second bearing 29 fixed to, and surrounded by the can 8, provides effective end stops between the lens carriage 32 and the can 8. This may reduce the possibility that that ball bearing 1030 surfaces (e.g. ramps 34 and ball bearing surfaces 37) may be damaged during impacts (for example dropping) to which a device incorporating the actuator assembly 23 may be subjected. Because the SMA wires 14₁, 14₂, 14₃, 14₄ do not have to be in the same plane as the balls 1030 in the bearings, it may be easier to implement an end stop system to permit the relatively large mass of a lens 10 and lens carriage 32 to be directly transferred to the can 8. Consequently, the bearing surfaces 37 and ramps 34 may be loaded only with the relatively low mass of the rotating annulus 33 and attached annular sheet 17.

In the actuator assembly 23, flexure of the beam portions 1003₁, 1003₂ of the second bearing 29 provides a restoring force urging the lens carriage 32 back to an equilibrium distance from the annular plate 16 (second part 25) along the primary axis z. Consequently, additional springs, magnets or other biasing means are not required, simplifying the actuator design and assembly. The ramps 34₁, 34₂, 34₃, 34₄ may be pre-stressed by a small amount of flexing in the equilibrium position. This pre-stressed configuration may also help to prevent significant tilt (rotation) of the lens carriage 32 between powered and unpowered states of the SMA wires 14₁, 14₂, 14₃, 14₄.

It will be appreciated that there may be many other variations of the above-described embodiments.

In the description hereinbefore, parts have been described as rectangular, and this should be interpreted as encompassing square shapes. In the description hereinbefore, parts have been described as circular, and this should be interpreted as encompassing elliptical shapes.

The first to fourth SMA wires 14₁, 14₂, 14₃, 14₄ have been described and shown as directly connecting the second and third parts 25, 28. However, in some examples the first to fourth SMA wires 14₁, 14₂, 14₃, 14₄ may indirectly connect the second and third parts 25, 28, for example via one or more intermediate structures (not shown). Intermediate structures (not shown) may be configured to help extend the stroke provided by the SMA wires 14₁, 14₂, 14₃, 14₄. In some examples, there may be further SMA wires 14.

In some examples, there may be less than four SMA wires 14 configured to apply a torque on the third part 28. For example, there may be one or two SMA wires equivalent to those described in WO 2019/243849 A1. However, in such examples, additional features (e.g. an additional bearing of any suitable type) may be needed to constrain movement of the third part 28 other than Rz. Such a constraint may be (at least) partly provided by the above described bearing arrangement 16.

The actuator assembly may be any type of assembly that comprises a first part which is movable with respect to a second part.

In some examples, the first (movable) part may correspond to, or include, an optical element which is not (even nominally) circularly symmetric and/or which should not be rotated as it is moved along the primary axis. In such an example, an actuator assembly as described in WO 2019/243849 A1 may be unsuitable, and the actuator assembly described herein may be particularly advantageous. For instance, the actuator assembly may be used as part of a time-of-flight system as described in WO 2020/030916 A1 or WO 2021/019230 A1 (incorporated herein in their entirety by this reference) wherein the (movable) optical element is e.g. a diffractive optical element configured to produce a pattern of light such as a dot pattern.

The actuator assembly may be, or may be provided in, any one of the following devices: a smartphone, a protective cover or case for a smartphone, a functional cover or case for a smartphone or electronic device, a camera, a foldable smartphone, a foldable smartphone camera, a foldable consumer electronics device, a camera with folded optics, an image capture device, an array camera, a 3D sensing device or system, a servomotor, a consumer electronic device, a mobile or portable computing device, a mobile or portable electronic device, a laptop, a tablet computing device, an e-reader, a computing accessory or computing peripheral device, an audio device, a security system, a gaming system, a gaming accessory, a robot or robotics device, a medical device, an augmented reality system, an augmented reality device, a virtual reality system, a virtual reality device, a wearable device, a drone, an aircraft, a spacecraft, a submersible vessel, a vehicle, and an autonomous vehicle, a tool, a surgical tool, a remote controller, clothing, a switch, dial or button, a display screen, a touchscreen, a flexible surface, and a wireless communication device. It will be understood that this is a non-exhaustive list of example devices.

1. An actuator assembly comprising:
a first part;
a second part;
a bearing arrangement mechanically coupling the first part to the second part, the bearing arrangement comprising a first bearing mechanically coupling the first part to a third part;
a drive arrangement comprising at least one length of shape memory alloy wire, wherein each length of shape memory alloy wire is connected between the third part and the second part;
wherein the drive arrangement and the bearing arrangement are configured such that in response to a torque applied about a primary axis by the drive arrangement, the first bearing generates movement of the first part towards or away from the second part and the third part along the primary axis;
wherein the bearing arrangement is configured to constrain rotation of the first part relative to the second part about the primary axis.

2. The actuator assembly according to claim 1, wherein the first bearing comprises a helical flexure.

3. The actuator assembly according to claim 1, wherein the first bearing comprises a helical bearing.

4. The actuator assembly according to claim 3, wherein the first bearing comprises a plurality of flexible ramps arranged in a loop about the primary axis.

5. The actuator assembly according to claim 4, wherein the flexible ramps are pre-stressed in an equilibrium or neutral configuration of the first bearing.

6. The actuator assembly according to claim 1, wherein the bearing arrangement comprises a second bearing mechanically coupling the first part to the second part and configured to guide movement of the first part towards or away from the second part along the primary axis whilst constraining movement of the first part relative to the second part along a first axis and/or a second axis, wherein the first and second axes are perpendicular to the primary axis and the second axis is different to the first axis, and also constraining rotation of the first part relative to second part about the primary axis.

7. The actuator assembly according to claim 6, wherein the second bearing comprises a ball-bearing race aligned with the primary axis.

8. The actuator assembly according to claim 6, wherein the second bearing comprises first and second sets of flexures, each flexure of the first and second sets of flexures configured to be compliant in a direction corresponding to movement of the first part relative to the third part along the primary axis, wherein the first and second sets of flexures are connected in parallel and spaced apart along the primary axis.

9. The actuator assembly according to claim 1, wherein the bearing arrangement further comprises a third bearing mechanically coupling the third part to the second part in parallel with the drive arrangement.

10. The actuator assembly according to claim 9, wherein the third bearing is configured to constrain movement of the third part relative to the second part along the primary axis, and to constrain rotation of the third part relative to the second part about first and/or second axes, wherein the first and second axes are perpendicular to the primary axis and the second axis is different to the first axis.

11. The actuator assembly according to claim 1, wherein the at least one length of shape memory alloy wire comprises four lengths of shape memory alloy wire that substantially co-planar within a plane perpendicular to the primary axis.

12. The actuator assembly according to claim 1, wherein at least one length of shape memory alloy wire comprises four lengths of shape memory alloy wire, and wherein each of the four lengths of shape memory alloy wire is not perpendicular to the primary axis.

13. A camera comprising:
an actuator assembly according to claim 1;
an image sensor supported by one of the first part and the second part;
a lens supported by the other of the first part and the second part.

14. The camera according to claim 13, further comprising a controller configured to control the actuator assembly to:
implement an auto-focus function using the movement of the first part towards or away from the second part along the primary axis.

15. A method comprising use of the actuator assembly according to claim 1 to implement an automatic focussing function of a camera.

16. The actuator assembly according to claim 1, wherein the drive arrangement comprises at least two lengths of shape memory alloy wire.

17. The actuator assembly according to claim 1, wherein the drive arrangement comprises four lengths of shape memory alloy wire.
